(19) United States
(12) Patent Application Publication
(10) Pub. No.: US 2015/0161545 A1
(43) Pub. Date: Jun. 11, 2015

(54) VISUALIZATION OF SPARE PARTS INVENTORY

(71) Applicant: Smart Software, Inc., Belmont, MA (US)

(72) Inventors: Thomas Reed Willemain, Niskayuna, NY (US); Nelson Seth Hartunian, Belmont, MA (US)

(21) Appl. No.: 14/559,493

(22) Filed: Dec. 3, 2014

Related U.S. Application Data
(60) Provisional application No. 61/912,158, filed on Dec. 5, 2013.

(51) Int. Cl. G06Q 10/06; G06Q 10/08

(52) U.S. Cl. CPC G06Q 10/06315; G06Q 10/087

(57) ABSTRACT

A system, method and program product for analyzing demand data from an inventory database. A inventory demand analysis system is described having: a system for accessing an inventory database of item data, wherein the item data includes a historical demand for items characterized with intermittent demand; a demand pattern association system that analyzes the historical demand to calculate a set of coincidence probabilities for pairs of items in the inventory database; and a graphical representation system for generating a visual representation of a demand structure of the inventory database based on the set of coincidence probabilities.

### PRIORITY CLAIM

This application claims priority to co-pending provisional application Ser. No. 61/912,158 filed on Dec. 5, 2013, entitled “VISUALIZATION OF SPARE PARTS INVENTORY” the contents of which are hereby incorporated by reference.

### FIELD OF THE INVENTION

This disclosure relates to discovering and visualizing demand data and more particularly to visualizing the relationships among items comprising an inventory of spare parts.

### BACKGROUND OF THE INVENTION

Many products and systems built and sold today (e.g., airplanes, automobiles, etc.) comprise thousands or even tens or hundreds of thousands of parts. Spare parts must be inventoried for such products for maintenance or related purposes. Maintaining such inventories can be a costly endeavor, as it is difficult to analyze and predict demand for such parts.

One such challenge involves the fact that demand for items such as spare parts is often intermittent, i.e., a mixture of many zero demands with nonzero demands of random sizes. Intermittent demand is difficult to analyze and forecast, since it violates the assumptions underlying most methods of statistical analysis, i.e., that successive observations are independent samples from identical Normal (Gaussian) distributions. U.S. Pat. No. 6,205,431, issued to Willemain et al., on Mar. 20, 2001, which is hereby incorporated by reference, describes techniques for forecasting intermittent demand of individual products.

### SUMMARY OF THE INVENTION

The present invention relates to a system, method and program product for discovering and visualizing relationships among items having intermittent demand, such as an inventory of spare parts.

In a first aspect, an inventory demand analysis system is provided, comprising: a system for accessing an inventory database of item data, wherein the item data includes historical demand for items characterized with intermittent demand; a demand pattern association system that analyzes the historical demand to calculate a set of coincidence probabilities for pairs of items in the inventory database; and a graphical representation system for generating a visual representation of a demand structure of the inventory database based on the set of coincidence probabilities.

In a second aspect, a computerized method of analyzing inventory demand is provided, comprising: accessing an inventory database of item data, wherein the item data includes a historical demand for items characterized with intermittent demand; analyzing the historical demand to calculate a set of coincidence probabilities for pairs of items in the inventory database; and generating a visual representation of a demand structure of the inventory database based on the set of coincidence probabilities.

In a third aspect, a computer program product stored on a computer readable medium is provided, which when executed by a processor, analyzes inventory demand, and comprises: program code for accessing an inventory database of item data, wherein the item data includes historical demand for items characterized with intermittent demand; program code for analyzing the historical demand to calculate a set of coincidence probabilities for pairs of items in the inventory database; and program code for generating a visual representation of a demand structure of the inventory database based on the set of coincidence probabilities.

### BRIEF DESCRIPTION OF THE DRAWINGS

These and other features of this invention will be more readily understood from the following detailed description of the various aspects of the invention taken in conjunction with the accompanying drawings.

FIG. 1 depicts a flow chart for discovering and visualizing relationships among items having intermittent demand.

FIG. 2 illustrates the calculations for notional demand series for a pair of items.

FIG. 3 depicts a flow chart for generating beta-binomial data.

FIG. 4 illustrates an example of the stationary bootstrap for an item.

FIG. 5 illustrates a beta-binomial graph.

FIG. 6 shows an example of a dendrogram.

FIG. 7 shows an illustrative multi-dimension scaling (MDS) plot.

FIG. 8 shows an illustrative network graph of clusters.

FIG. 9 summarizes the number of connected components for the network graph in FIG. 8.

FIG. 10 depicts an internal structure of one connected component of FIG. 8.

FIG. 11 depicts a graphical output that utilizes metadata to further describe a cluster.

FIG. 12 depicts a computer system having a spare parts visualization system in accordance with an embodiment of the invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Practitioners typically manage items such as those found in spare parts inventories, on an individual basis, having no means to detect and exploit relationships among items based on their shared demand patterns. The embodiments described herein detect such relationships by statistical analysis, quantifying the similarity of items' demand patterns, and then present the user with visualizations of those relationships. Although the description is generally directed at spare parts inventories, the approach can be used for any type of demand management in which data associated with a large number of items (i.e., inventory) having intermittent demand are tracked and managed. For the purposes of this disclosure, items may include physical articles such as parts, virtual concepts such as computing resources, energy consumption, financial data, etc., or any manifestation for which a demand history is maintained.

The visualizations described herein allow the user to appreciate any substructure in an inventory, i.e., “clustering” of items into parts “families”. There are several potential uses for this knowledge, including:
Items whose demand patterns correlate with those of other items might be forecasted more accurately by exploiting those associations.
Items that have no associations with other items would be confirmed as best forecasted on an individual basis, as is done now.
Items grouped into the same cluster (or “family”) might best be co-located in warehouses, so that retrieval might be done more efficiently.
Items in the same family might be assigned to different “item managers” to minimize fluctuations in the item managers' workloads.
Firms with multiple inventories could compare them qualitatively to see whether they should be managed in the same or different ways.

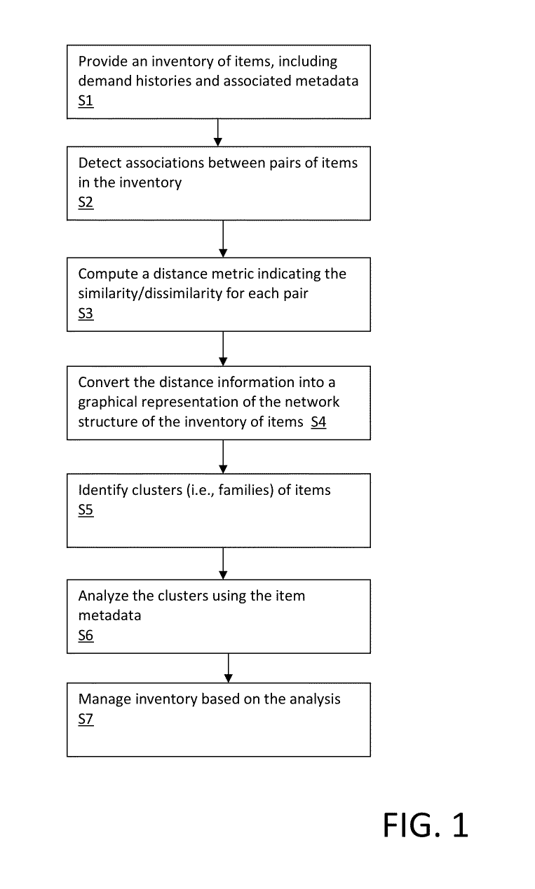

An illustrative process is described in the flow chart shown in FIG. 1. At S1, an inventory of items is provided including demand histories for each item and associated metadata for each item. The inventory of items includes a substantial number of items characterized as having intermittent demand (e.g., at least 20% zero demand), which are processed as follows. At S2, associations (i.e., coincidence probabilities) between item pairs are detected. In other words, each item having intermittent demand in the inventory is evaluated against each other such item, thus generating a matrix of coincidence probability values.

At S3, distance information is computed, which includes a distance metric for each item pair indicating a similarity (or dissimilarity). At S4, the distance information is converted into a graphical representation of a demand structure of the inventory of items and at S5, clusters (i.e., families) of items are identified either from the visual representation or from the raw data (e.g., the matrix of coincidence probability values). At S6, item metadata (e.g., warehouse location, vendor name, unit cost, etc.) is used to analyze the clusters, and at S7, the inventory is managed based on the analysis.

These processes are described in further detail as follows:

### Detection of Association Between Demand Patterns of any Two Items.

Items can be clustered along many dimensions. For instance, spare parts can be grouped by whether their suppliers are foreign or domestic, or on the basis of their cost or procurement lead times. However, for these embodiments, clustering is done on the basis of similarity of demand patterns, i.e., identifying items whose demands ebb and flow together.

As noted, spare parts and many types of finished goods typically have unit demand patterns that are characterized as intermittent, i.e., the patterns include a mixture of many zero demands with nonzero demands of random sizes. As noted, intermittent demand is difficult to analyze and forecast, since it violates the assumptions underlying most methods of statistical analysis, i.e., that successive observations are independent samples from identical Normal (Gaussian) distributions. As a result, the statistic usually used to summarize the association between two random variables, the correlation coefficient, does not work well with intermittent demand data.

Embodiments of the invention thus implement alternatives to correlation analysis. One such approach involves coincidence probability, defined as the probability that both members of a pair of items have nonzero demand in the same time period (a coincidence) if such coincidences occurred entirely at random. If the number of coincidences is unusually large relative to the number that chance would generate, then the two items are considered to be related. (Conversely, if the number of coincidences is relatively small, then the two items are also considered to be related, albeit inversely.) Calculation of the coincidence probability begins by converting the history of unit demands for each item to a binary form (zero if the demand was zero or one if the demand was non-zero); this step removes the irrelevant factor of average demand size from the calculation of strength of relationship. The two binary demand sequences are then analyzed with due regard to the total number of observations, the number of nonzero demands in each item's history, and the extent of autocorrelation in each item's demand.

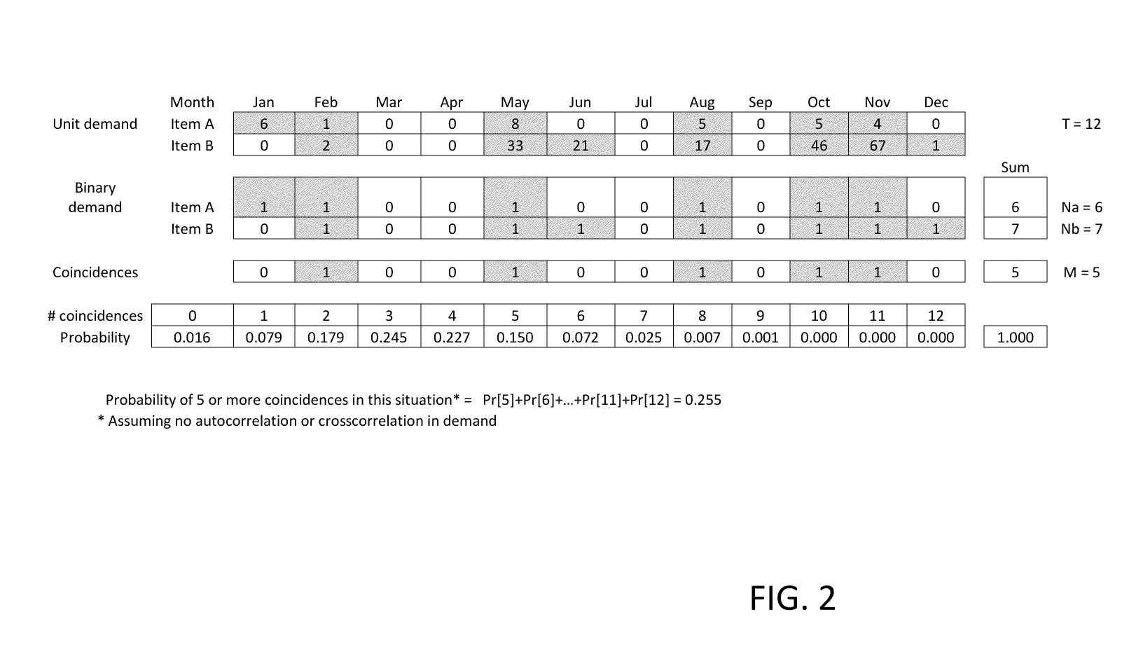

FIG. 2 illustrates the calculations for notional demand series for Item A and Item B. Both items have T=12 demand observations, containing Nₐ=6 nonzero demands for Item A and N_{b}=7 for item B. As seen, nonzero demands coincided in C=5 time periods, i.e., there were five coincidences. Assuming that each item has independent demand (i.e., no autocorrelation) and that the two items' demand sequences are independent (i.e., no crosscorrelation), a binomial probability model describes the number of coincidences that might be generated by these two items. Estimating the probability of a demand as Nₐ/T=6/12 for Item A and N_{b}=7/12 for Item B, the binomial distribution has parameters n=12 and p=(6/12)·(7/12). It follows that the probability of observing five or more coincidences is not remarkable, being 0.255. Following the customary practice for hypothesis testing, any result with a probability below a selected threshold, e.g., 0.05, is declared to be statistically significant and the two items would be considered associated. In the depicted example, items A and B are not associated since they have a coincidence probability of 0.255.

In practice, many items' demand series are not independent; rather, they exhibit autocorrelation, so the simplified analysis described above is modified to account for autocorrelation. Two technical illustrative approaches are described to address this problem, one parametric and the other nonparametric.

The parametric approach is to presume a two-state Markov model of demand (states “zero” and “nonzero”), estimate the state transition probabilities, then estimate the distribution of the number of coincidences either by Monte Carlo simulation, using sample demand sequences generated by the two Markov models, or by matrix-analytic methods.

The nonparametric approach does not require the assumption of Markov models. In the nonparametric approach, a stationary bootstrap is used to generate the sample demand sequences, which are then used in a Monte Carlo analysis to calibrate a beta-binomial probability model.

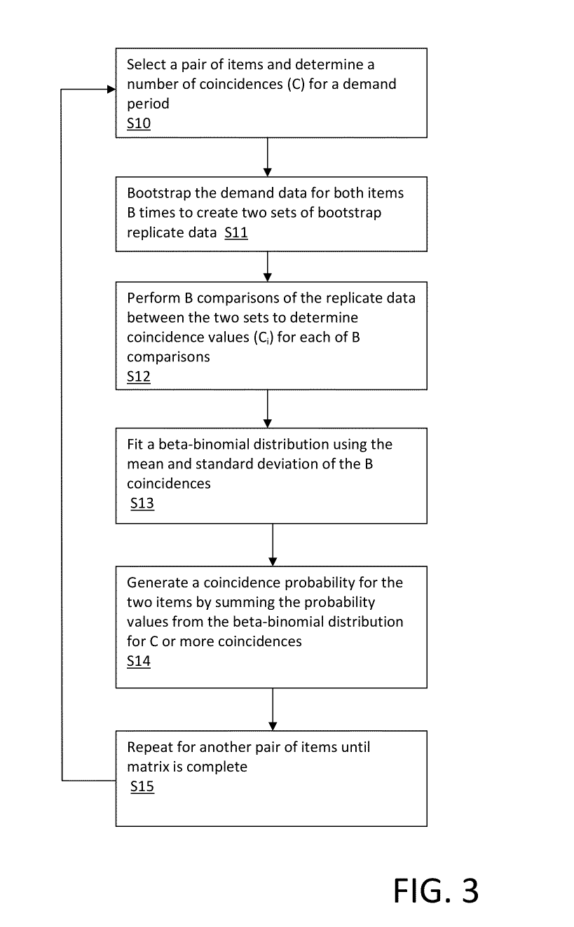

The flow chart shown in FIG. 3 details an illustrative process for implementing a nonparametric approach. At S10, a pair of items from the inventory are selected and a number of coincidences C are determined from the demand history of both (e.g., over the past 12 or 36 months). Next, using a stationary bootstrap, demand data for both items are bootstrapped to create two sets of bootstrap replicates at S11.

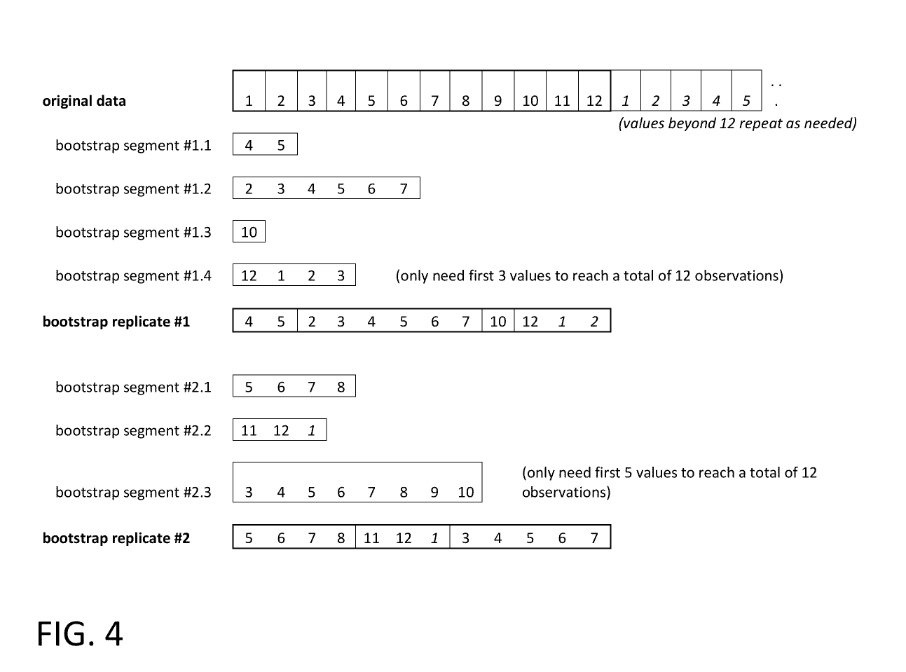

The stationary bootstrap works by randomly selecting blocks of consecutive observations and concatenating them until a bootstrap replicate of the correct length has been assembled. This procedure aims to reproduce the autocorrelation in the sequence. FIG. 4 illustrates an example of the stationary bootstrap for a first item. The sequence of demand values in the example has 12 observations, labeled 1-12 to clarify the exposition, but understood to be of intermittent character. Note that the demand sequence is “wrapped around” so that observation 1 is regarded as occurring after observation 12. In the illustration, the first bootstrap replicate is comprised of four segments. Segment #1.1 begins at (randomly-chosen) observation 4 and includes two observations (the segment length being a random sample from a geometric distribution with a user-chosen mean). The second segment #1.2 includes observations 2-7; the third segment #1.3 consists of a single observation (10); the final segment #1.4 starts at observation 12 and wraps around to include observations 1-3. Concatenating the four segments produces a bootstrap replicate of length 13, so the final observation is deleted to make a replicate of length 12, matching the length of the original demand sequence. The second bootstrap replicate in FIG. 4 is similarly formed from three segments (#2.1-#2.3). This process is then repeated for the first item until a large number of replicated demand sequences or replicates (e.g., 200) are generated. The entire process is then repeated for the second item. Thus, a set of replicates is generated for both items in the item pair.

The bootstrap step is intermediate, providing inputs to a subsequent step, in which a beta-binomial probability model is used to estimate the distribution of coincidences. As described, the stationary bootstrap is used to produce a large number B, e.g., 200, replicates of each demand sequence. Then, at S12 each pair of bootstrap replicates is compared to calculate the simulated number of coincidences. Thus, for example, the first replicate from item A is compared to the first replicate of item B; the second replicate of item A is compared to the second replicate of item B; and so on. Each comparison results in a coincidence value Cᵢ (where i=1 . . . B).

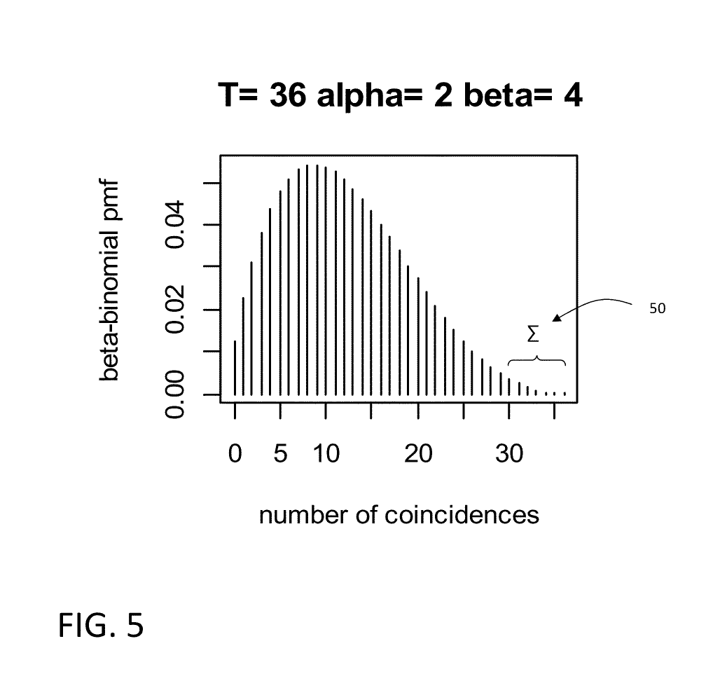

Next, at S13, the mean and standard deviation of the B coincidence values Cᵢ are used to determine the two parameters (α and β) of a beta-binomial distribution. FIG. 5 shows a beta binomial distribution fit to 36 observations with parameters α=2 and β=4. Next, at S14, the coincidence probability for the two items is determined by summing the probability values from the beta-binomial distribution for C or more coincidences (where C was the observed number of coincidences in the actual demand sequences of the two items). Thus, in the case of FIG. 5, assuming C were 30, the following values would be summed (as shown by reference numeral 50) from the beta binomial distribution: C(30)+C(31)+C(32)+C(33)+C(34)+C(35)+C(36), which would be approximately 0.01. Accordingly, the coincidence probability for the pair of items would be 0.01.

The process is then repeated at S15 for each different pair of items in the inventory. This approach duplicates well the Markov modeling approach when the Markov model holds, but also accommodates more complex models of demand.

### Computation of a Distance Metric Indicating the Similarity/Dissimilarity of the Items.

The above process creates a “coincidence matrix” of probabilities. Each row and column in the matrix represents an item, and the content of each cell in the matrix is the coincidence probability computed by comparing the demand patterns of the two items as in the above process. A simplified illustrative probability matrix would look as follows:

| | Item 1 | Item 2 | Item 3 | Item 4 | Item 5 | Item m |
|---|---|---|---|---|---|---|
| Item 1 | x | 0.05 | 0.006 | 0.21 | 0.0008 | 0.009 |
| Item 2 | 0.05 | x | 0.075 | 0.001 | 0.09 | 0.006 |
| Item 3 | 0.006 | 0.075 | x | 0.25 | 0.15 | 0.45 |
| Item 4 | 0.21 | 0.001 | 0.25 | x | 0.50 | 0.004 |
| Item 5 | 0.0008 | 0.09 | 0.15 | 0.50 | x | 0.12 |
| Item m | 0.009 | 0.006 | 0.45 | 0.004 | 0.12 | x |

These probabilities are low (near 0) if the two items are strongly associated and high otherwise. Existing systems to convert such a matrix into a graphical representation require the conversion of the probability values into “distance” values. Cells with low coincidence probabilities indicate pairs of items that are “close together”, so low probabilities should convert into low distances. There are many ways to make this conversion. One is to simply let the distances be the coincidence probabilities. Another is to make the distances binary, setting the distance between two items to 0.0 if their coincidence probability is less than, e.g., 0.05, and setting it to 1.0 otherwise.

Conversion of the Distance Information into a Graphical Representation of the Demand Structure of the Inventory.

Any type of graphical representation may be utilized to display the demand structure of an inventory, including, 2D and 3D representations, as well as tables. Existing tools for generating graphical representations of graph data are known in the art, including open source products, igraph and Gephi. The graphical representation is configured to be readily outputted on a computer display or other type of output (e.g., printed output). The representations may be interactive in nature, e.g., allowing a user to select areas of interest, zoom in and out, etc. In an illustrative application, the demand structure generally comprises a graph structure of connected components, e.g., if items x and y are associated (have similar demand) they would be connected in the graph based on their distance metric; if items y and z are associated, they would be connected in the graph based on their distance metric, etc.

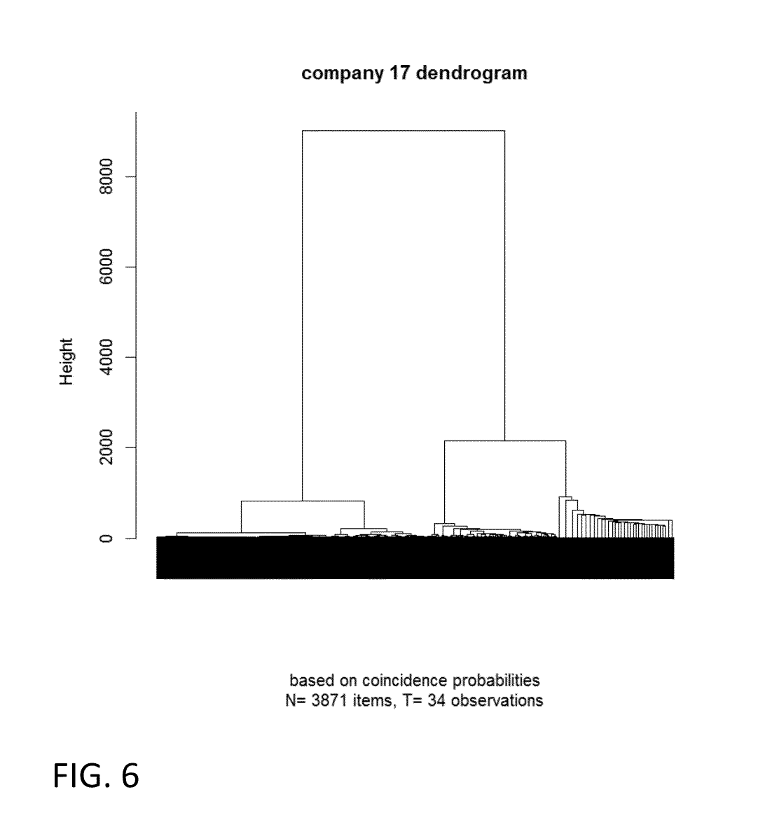

If the coincidence probabilities are left in their original form and regarded as distances, one standard way to use this information to depict demand structure for the data is to compute a “dendrogram”. FIG. 6 shows an example of a dendrogram. The top of the dendrogram represents all the parts in the inventory. Based on the inter-item distances, the complete inventory is subdivided into clusters or families, which in turn are further subdivided until the bottom level of the dendrogram represents all the individual parts in the inventory. The lengths of the vertical lines denoting subdivisions correspond to the degree of difference between the subdivisions: long vertical lines mean that the subdivisions have very different demand patterns, whereas short vertical lines mean that the subdivisions contain items with very similar demand patterns.

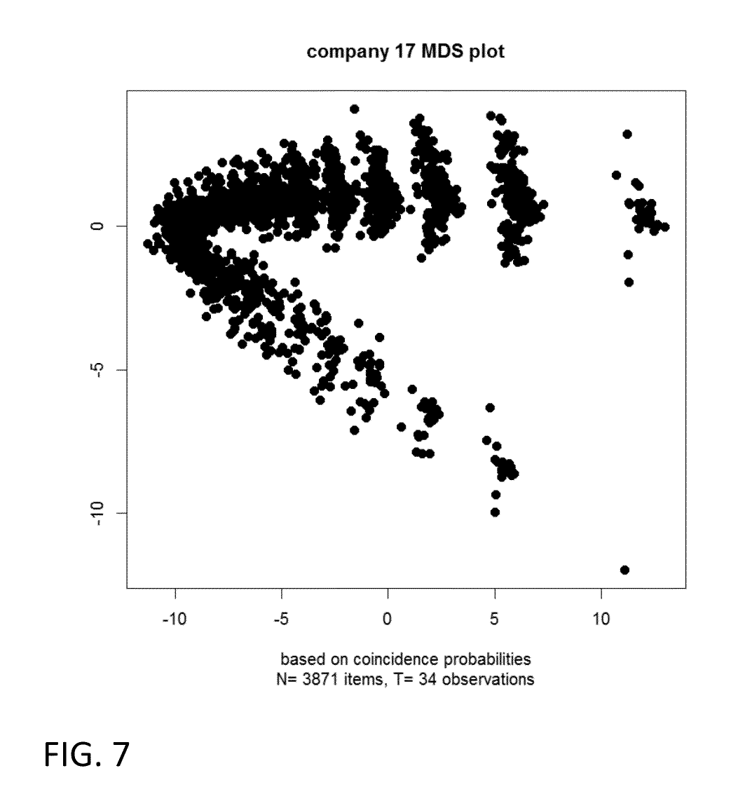

A second demand structure used to depict coincidence probabilities is a “multidimensional scaling plot” (MDS plot), such as that shown in FIG. 7. Points representing items are arranged in an MDS plot in such a way that the spatial distance between any two items (points) in the plot correlates with their distance as computed from their coincidence probability. The clustering in the inventory is clear from the “clumping” of points in the MDS plot.

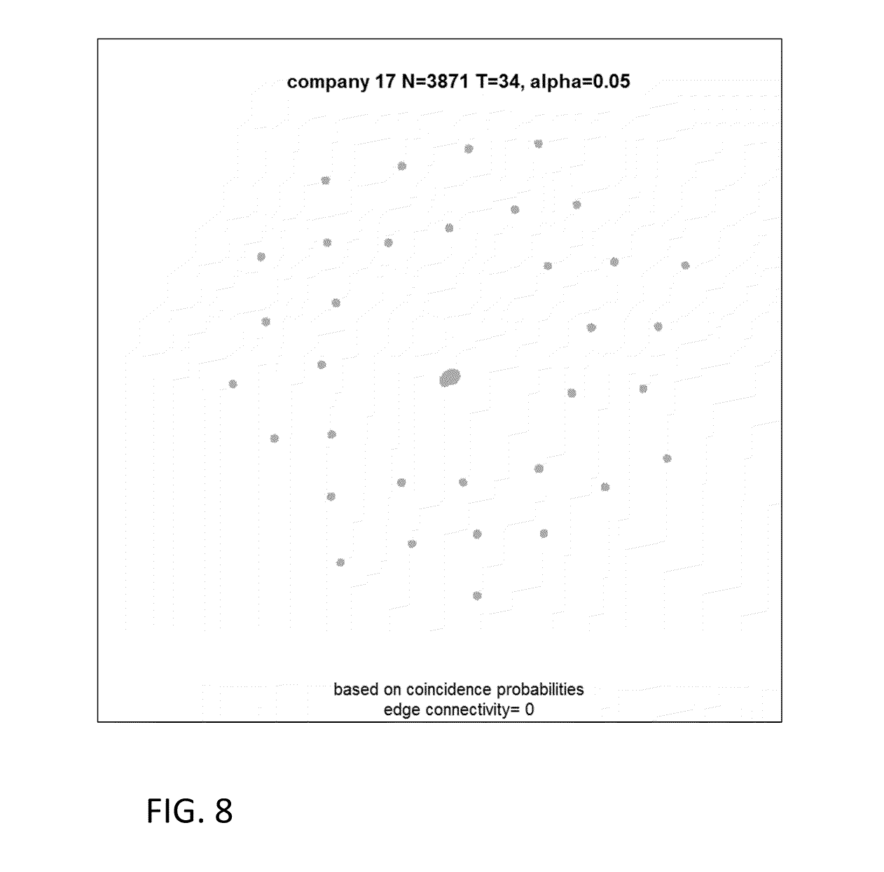

Further, if the coincidence probabilities are converted into a binary distance matrix, one can represent the structure of the entire inventory using an “adjacency matrix” identical to the distance matrix. The adjacency matrix indicates which items share demand patterns with which others. Standard software can render the information in an adjacency matrix as a “network graph”. FIG. 8 shows such a graph, wherein each “dot” represents a cluster. Within each cluster, a node (vertex) represents an item and two items with significant coincidence probability are connected by an arc (link). The structure of the network graph provides a way to detect the presence of parts families within an inventory, or to compare two inventories. For instance, nodes that are isolated represent parts which are best forecasted using their own demand histories. In contrast, nodes connected to multiple other nodes represent parts having “personal clusters” that might be exploited to improve forecast accuracy and therefore manage inventory more efficiently.

### Identification of Clusters or Families of Parts.

When coincidence probabilities are converted into graphical representations such as dendrograms, MDS plots, or network graphs identifying parts clusters (i.e., families) may depend on professional judgement. Accordingly, this step may be fully automated, partially automated, or performed by the user viewing the graphical representation. In the case of dendrograms, the judgement involves deciding where to “cut” the dendrogram horizontally. Any horizontal line through a dendrogram creates a mutually exclusive and collectively exhaustive set of parts families. In the case of MDS plots, the presence of and membership in parts families depends on an interpretation of the “clumpiness” of the plot.

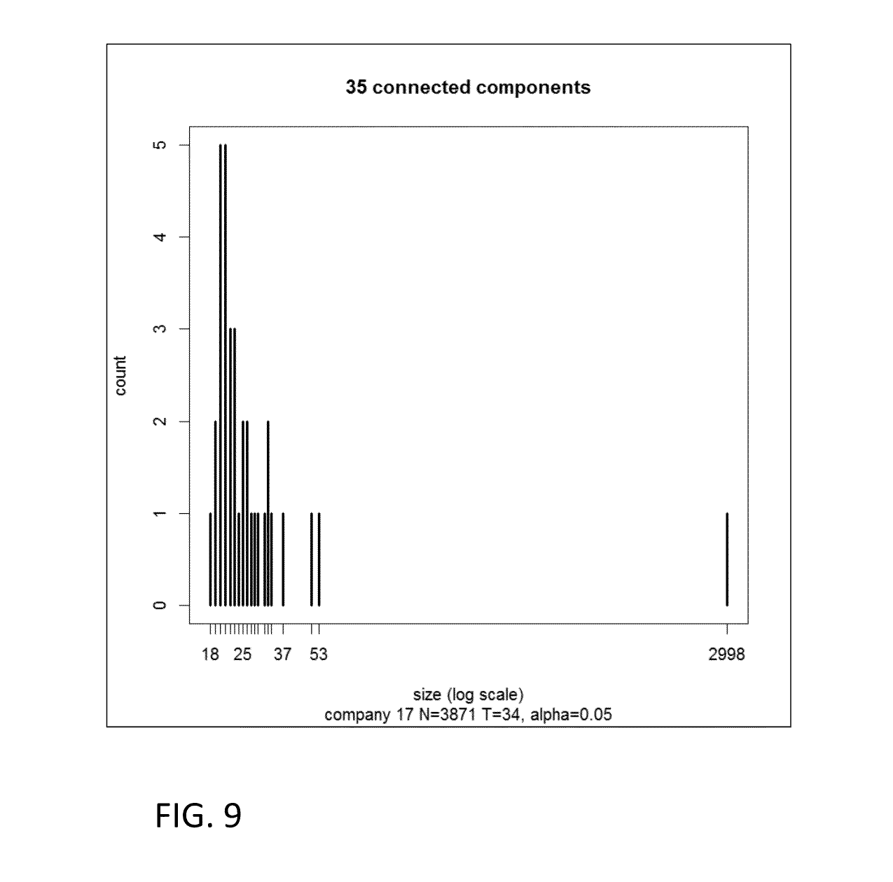

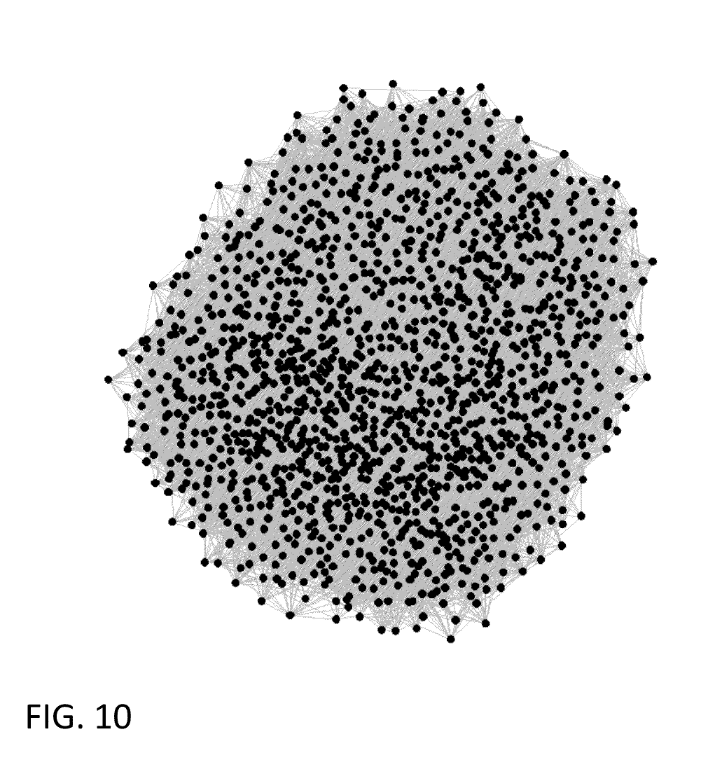

In the case of network graphs, automated discovery of clusters using methods of “community detection in graphs” may be employed. One simple approach is to identify clusters with “connected components”, i.e., subsets of the graph which have paths among all elements of the subset but no paths outside the subset. FIG. 9 summarizes the number of connected components, and the number of items in each, for the network graph in FIG. 8. The internal structure of each connected component can be complex, as illustrated in FIG. 10.

In general, this approach can be computationally intense because there is often a very large component containing a plurality of items but having some sort of internal structure that must be detected and used to break the large component into functionally meaningful sub-components. Such sub-components (communities) can be defined, roughly, as subsets of nodes which have many more connections within the subset than outside the subset. Several approaches exist to defining parts communities in this way.

### Interpretation of Clusters Using Item Metadata

Once clusters have been identified, appropriate inventory management action depends on properly understanding and interpreting the clusters. The statistical processing might reveal something like “Cluster number 23 contains these 85 spare parts”, but the user (or automated system) must understand the nature of those 85 parts before making use of that information. For instance, if the items are scattered over five different warehouses, it may be expedient to co-locate them in a single warehouse.

One approach to interpreting the meaning of a cluster of items is to analyze the items' metadata. The metadata available will vary from inventory to inventory, but often includes information such as warehouse location, supplier, item category (e.g., hydraulic, mechanical, electrical), priority (“A”, “B”, or “C”), unit cost, replenishment lead time, make or buy, and other operationally meaningful attributes.

Metadata characterizing each cluster can be presented in both tabular and graphical form. A user intimately familiar with the items may value the ability to scan down a list of cluster items and their associated metadata to form an interpretation of the cluster. Nevertheless, graphical depictions are also likely to be informative. For instance, the network graph might depict the nodes in the graph (items) using colors, shapes, pictures or sizes corresponding to item metadata (e.g., more expensive items displayed as larger circles, or domestic sources shown in blue and foreign sources in green). Furthermore, summary statistics can be displayed in ways that contrast clusters, such as bar charts or boxplots comparing the lead times in each cluster.

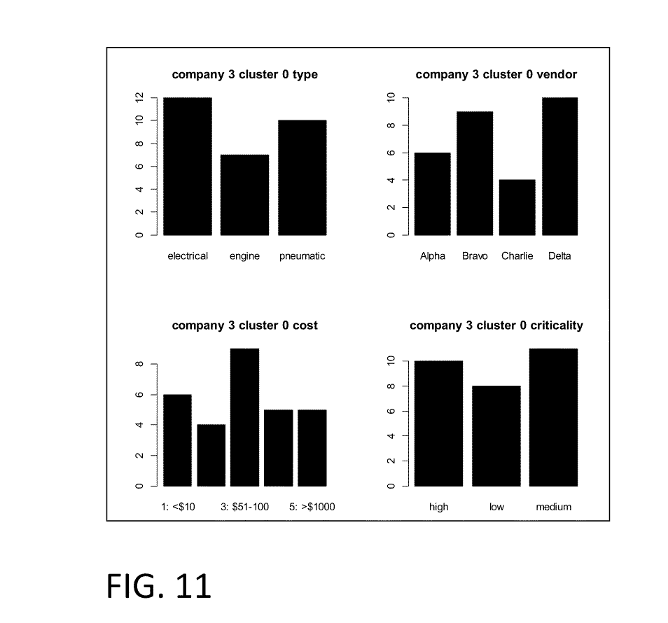

FIG. 11 depicts a graphical representation of an illustrative spare parts cluster in which four metadata-based views show distributions of information in the cluster. For example, in the top left-hand corner, items within the cluster are broken down by type, i.e., “electrical,” “engine,” or “pneumatic.” The other views show the cluster broken down by vendor, cost and criticality.

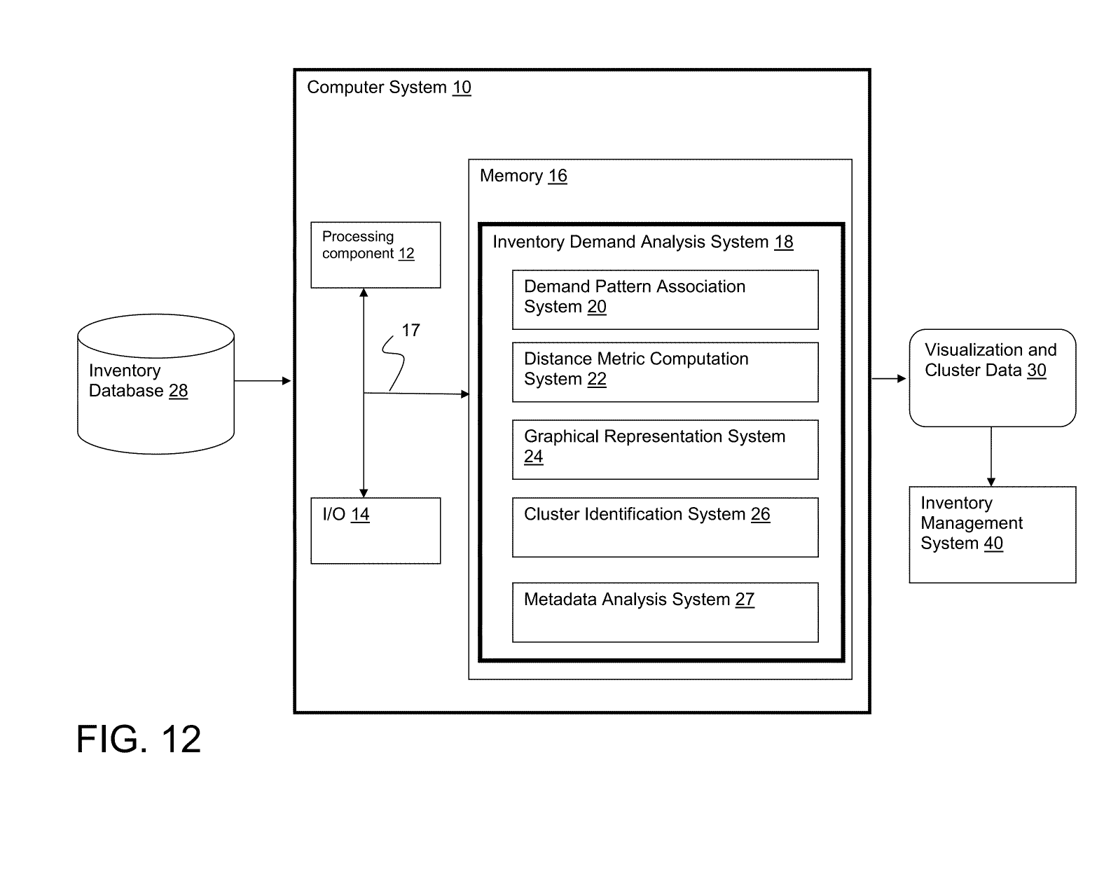

FIG. 12 depicts an embodiment of a computer system 10 having an inventory demand analysis system 18 for generating visualization and cluster data 30, which can be utilized by an inventory management system 40 to more effectively manage inventory. Inventory demand analysis system 18 includes a demand pattern association system 20 for calculating demand probabilities for pairs of items from an inventory database 28; a distance metric computation system 22 for computing distance values between pairs of items; a graphical representation system 24 for generating a visual representation of the network structure of item demand in the inventory database 28; a cluster identification system 26 for identifying clusters (i.e., families of items) from the visual representation; and a metadata analysis system 27 for incorporating metadata into the generated visualization and cluster data 30.

Computer system 10 is shown including a processing component 12 (e.g., one or more processors), a memory 16 (e.g., a storage hierarchy), an input/output (I/O) component 14 (e.g., one or more I/O interfaces and/or devices), and a communications pathway 17. In general, processing component 12 executes program code, such as demand analysis system 18, which is at least partially fixed in memory 16. While executing program code, processing component 12 can process data, which can result in reading and/or writing transformed data from/to memory 16 and/or I/O component 14 for further processing. Pathway 17 provides a communications link between each of the components in computer system 10. I/O component 14 can comprise one or more human I/O devices, which enable users or other devices to interact with computer system 10. To this extent, demand analysis system 18 can manage a set of interfaces (e.g., graphical user interface(s), application program interfaces, etc.) that enable interaction with demand analysis system 18. Further, demand analysis system 18 can manage (e.g., store, retrieve, create, manipulate, organize, present, etc.) data, such as data in database 28, using any solution. Furthermore, given the computing complexity necessary to process tens or hundreds of thousands of items in a typical inventory database, computer system 10 may employ processing techniques such as multi-threading, grid computing, supercomputing, or other known approaches to increase the processing efficiency of computer system 10.

In any event, computer system 10 can comprise one or more general purpose computing articles of manufacture (e.g., computing devices) capable of executing program code, such as inventory demand analysis system 18, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, inventory demand analysis system 18 can be embodied as any combination of system software and/or application software.

Further, inventory demand analysis system 18 can be implemented using a set of modules 20, 22, 24, 26, 27. In this case, a module can enable computer system 10 to perform a set of tasks used by inventory demand analysis system 18, and can be separately developed and/or implemented apart from other portions of inventory demand analysis system 18. As used herein, the term “component” means any configuration of hardware, with or without software, which implements the functionality described in conjunction therewith using any solution, while the term “module” means program code that enables a computer system 10 to implement the actions described in conjunction therewith using any solution. Regardless, it is understood that two or more components, modules, and/or systems may share some/all of their respective hardware and/or software. Further, it is understood that some of the functionality discussed herein may not be implemented or additional functionality may be included as part of computer system 10.

When computer system 10 comprises multiple computing devices, each computing device can have only a portion of inventory demand analysis system 18 fixed thereon (e.g., one or more modules). However, it is understood that computer system 10 and inventory demand analysis system 18 are only representative of various possible equivalent computer systems that may perform a process described herein. To this extent, in other embodiments, the functionality provided by computer system 10 and inventory demand analysis system 18 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 10 includes multiple computing devices, the computing devices can communicate over any type of communications link. Further, while performing a process described herein, computer system 10 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

While shown and described herein as a method and system for processing spare parts data, it is understood that aspects of the invention further provide various alternative embodiments. For example, in one embodiment, the invention provides a computer program fixed in at least one computer-readable medium, which when executed, enables a computer system to process spare parts data. To this extent, the computer-readable medium includes program code, such as inventory demand analysis system 18, which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as inventory demand analysis system 18, which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for processing spare parts data. In this case, a computer system can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

It is understood that aspects of the invention can be implemented as part of a business method that performs a process described herein on a subscription, advertising, and/or fee basis. That is, a service provider could offer to process spare parts data as described herein. In this case, the service provider can manage (e.g., create, maintain, support, etc.) a computer system, such as computer system 10, that performs a process described herein for one or more customers. In return, the service provider can receive payment from the customer(s) under a subscription and/or fee agreement, receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. An inventory demand analysis system, comprising;
a system for accessing an inventory database of item data, wherein the item data includes historical demand for items characterized with intermittent demand;
a demand pattern association system that analyzes the historical demand to calculate a set of coincidence probabilities for pairs of items in the inventory database; and
a graphical representation system for generating a visual representation of a demand structure of the inventory database based on the set of coincidence probabilities.

2. The inventory demand analysis system of claim 1, wherein the set of coincidence probabilities forms a matrix.

3. The inventory demand analysis system of claim 1, further comprising a distance metric computation system that converts each coincidence probability into a distance metric.

4. The inventory demand analysis system of claim 1, further comprising a cluster identification system for identifying clusters from at least one of: the visual representation and the set of coincidence probabilities.

5. The inventory demand analysis system of claim 1, further comprising a metadata analysis system that incorporates metadata from the inventory database into the visual representation.

6. The inventory demand analysis system of claim 1, wherein the set of coincidence probabilities are calculated using a parametric process in which a two-state Markov model of demand is employed, comprising:
estimating state transition probabilities; and
estimating the distribution of the number of coincidences using one of: a Monte Carlo simulation, using sample demand sequences generated by two Markov models; and a matrix-analytic methodology.

7. The inventory demand analysis system of claim 1, wherein the set of coincidence probabilities are calculated using a non-parametric process, comprising:
selecting a pair of items and determining a number of coincidences in a demand sequence for both items over a demand period;
bootstrapping a set of demand sequences for each item to create two sets of bootstrap replicate data;
comparing demand sequences from the two sets of bootstrap replicate data to generate a set of coincidence values;
fitting a beta-binomial distribution to the set of coincidence values; and
calculating a coincidence probability for the two items based on the beta-binomial distribution.

8. A computerized method of analyzing inventory demand, comprising;
accessing an inventory database of item data, wherein the item data includes a historical demand for items characterized with intermittent demand;
analyzing the historical demand to calculate a set of coincidence probabilities for pairs of items in the inventory database; and
generating a visual representation of a demand structure of the inventory database based on the set of coincidence probabilities.

9. The computerized method of claim 8, wherein the set of coincidence probabilities forms a matrix.

10. The computerized method of claim 8, further comprising converting each coincidence probability into a distance metric.

11. The computerized method of claim 8, further comprising automatically identifying clusters from at least one of: the visual representation and the set of coincidence probabilities.

12. The computerized method of claim 8, further comprising incorporating metadata from the inventory database into the visual representation.

13. The computerized method of claim 8, wherein the set of coincidence probabilities are calculated using a parametric process in which a two-state Markov model of demand is employed, comprising:
estimating state transition probabilities; and
estimating the distribution of the number of coincidences using one of: a Monte Carlo simulation, using sample demand sequences generated by two Markov models; and a matrix-analytic methodology.

14. The computerized method of claim 8, wherein the set of coincidence probabilities are calculated using a non-parametric process, comprising:
selecting a pair of items and determining a number of coincidences in a demand series for both items over a demand period;
bootstrapping a set of demand sequences for each item to create two sets of bootstrap replicate data;
comparing demand sequences from the two sets of bootstrap replicate data to generate a set of coincidence values;
fitting a beta-binomial distribution to the set of coincidence values; and
calculating a coincidence probability for the two items based on the beta-binomial distribution.

15. A computer program product stored on a computer readable medium, which when executed by a processor, analyzes inventory demand, and comprises;
program code for accessing an inventory database of item data, wherein the item data includes historical demand for items characterized with intermittent demand;
program code for analyzing the historical demand to calculate a set of coincidence probabilities for pairs of items in the inventory database; and
program code for generating a visual representation of a demand structure of the inventory database based on the set of coincidence probabilities.

16. The computer program product of claim 15, further comprising program code for converting each coincidence probability into a distance metric.

17. The computer program product of claim 15, further comprising program code for automatically identifying clusters from at least one of: the visual representation and the set of coincidence probabilities.

18. The computer program product of claim 15, further comprising program code for incorporating metadata from the inventory database into the visual representation.

19. The computer program product of claim 15, wherein the set of coincidence probabilities are calculated using a parametric process in which a two-state Markov model of demand is employed, comprising:
estimating state transition probabilities; and
estimating the distribution of the number of coincidences using one of: a Monte Carlo simulation, using sample demand sequences generated by two Markov models; and a matrix-analytic methodology.

20. The computer program product of claim 15, wherein the set of coincidence probabilities are calculated using a non-parametric process, comprising:
selecting a pair of items and determining a number of coincidences in a demand sequences for both items over a demand period;
bootstrapping a set of demand sequences for each item to create two sets of bootstrap replicate data;
comparing demand sequences from the two sets of bootstrap replicate data to generate a set of coincidence values;
fitting a beta-binomial distribution to the set of coincidence values; and
calculating a coincidence probability for the two items based on the beta-binomial distribution.
